(19) United States
(12) Patent Application Publication
(10) Pub. No.: US 2004/0009370 A1
(43) Pub. Date: Jan. 15, 2004

(54) Magnet sheet for display and method of manufacturing the same

(76) Inventor: Seiji Abe, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/190,542

(22) Filed: Jul. 9, 2002

(51) Int. Cl. B29D 24/00

(52) U.S. Cl. 428/693; 428/900; 264/500

(57) ABSTRACT

It is sought to provide a magnet sheet for display, which, while being as large as A3 to A4 sizes or more, is free from being broken or formed with holes, has a desired uniform thickness, permits ready printing on it with a plotter, a copier or like printing machine, is excellent in the magnetic attachment property and permits a heretofore unseen, magnetically attachable large size advertisement poster.

A magnet sheet 1 for display is formed by laminating a print sheet 3 of paper or synthetic resin film having a thickness of 0.1 to 0.2 mm on either one or each surface of a magnet sheet 2 having a width of 600 mm or more, a length capable of being set as desired and a thickness of 0.1 to 0.2 mm and magnetically attachable to a magnetic surface. A desired display such as a painting, letters, drawings and photographs is printed on the surface of the print sheet by using a plotter, a copier, a printer or like printing machine.

### BACKGROUND OF THE INVENTION

1. Field of the Invention

This invention relates to a magnetic sheet for display and a method of manufacturing the same, which is magnetically attachable to a magnetic surface, permits printing of desired letters, drawings, paintings, photographs, etc. on it with a printing machine, such as a plotter, a copier, a laser printer, an ink jet printer, an ink ribbon type heat-sensitive printer and a dot printer, and can be effectively used for production of a broad display member such as an advertisement poster.

2. Prior Art

Heretofore existing display articles use magnetic sheets, which have such convenience that they can be magnetically detachably attached to any surface so long as the surface is of a magnetic member. However, these display particles are manufactured by such means as silk printing, which is used for printing on a white vinyl chloride surface coated on a magnetic sheet while it requires a plate for each color, or as preliminary preparation of a display sheet formed by printing with a printer and attaching the display sheet of a magnetic sheet. Therefore, the display particles are expensive, and their kinds and display contents are inevitably specified. In this circumstance, in general homes and offices, it is possible only to purchase an existing magnetic sheet for display, which has display contents preliminarily formed by printing, from an expert shop as desired. This means that a magnetic sheet for display having desired display contents has to be given up when it is not found in any shop.

As a measure of drastic overcoming of the above drawbacks, a magnetic sheet for display which is capable of being printed by such printer as a copier, has been developed by applying a print sheet made of paper, e.g., high grade paper, coated paper, etc., synthetic paper or synthetic resin film and having a thickness of 0.05 to 0.15 mm to one surface of a magnetic sheet, which is formed from a mixture of synthetic resin material and magnetic particles to a sheet-like form having a thickness of 0.05 to 0.15 mm and has the other surface multiple-pole magnetized to alternate N and S poles, the magnetic sheet of display thus having a thickness of 0.15 to 0.3 mm.

This magnetic sheet for display permits, in lieu of purchasing any existing magnet sheet for display, quick and ready display of desired display contents with a copier, a printer or like printing machine used in usual homes and offices, and the printed magnetic sheet for display can be detachably magnetized on the magnetic surface of a steel board, a white board, etc.

FIG. 5 shows a method of manufacturing a magnet sheet for display. As shown, a mixture paste 101 composed of synthetic resin material and magnetic articles, is rolled by passing it through many calendar roller stages 102 until its thickness is reduced to obtain a paste sheet 103 having a final desired thickness. A print sheet composed of paper or synthetic resin film is then laminated on the paste sheet. The laminate thus formed is then brought to a magnetizing process using a magnetizing yoke. In this way, the magnetic sheet for display as noted above is obtained.

However, in a method using a calendar machine for passing the paste through a multiple calendar roller stages, limitations are imposed on width and length dimensions of the magnetic sheet for display. Typically, the width is determined by the roller width. Besides, the weight ratio of magnetic particles in the paste sheet composed of the synthetic resin material and magnetic particles, is 90% or above. Thus, compared to the case of the sole synthetic resin material, the specific gravity is high, and the viscosity is low. The paste sheet is thus fragile and is subject to breakage and hole formation. Actually, the paste sheet is obtainable only up to A4 to A3 sizes, and it is difficult to obtain a magnetic sheet for display, which is wide, long, suited for printing with a copier, a printer or like printing machine and excellent in magnetizing performance. Therefore, the purposes of the paste sheet are limited, and it has been impossible to manufacture a large display member such as a wide and long advertisement poster.

In the method of sheet formation using calendar rollers, since the paste of the synthetic resin material and magnetic particles is rolled for gradual thickness control by passing it through a plurality of calendar roller stages, it is inevitable to use a complicated apparatus. In addition, high dimensional accuracy can not be expected, and the thickness accuracy of the sheet that can be formed is about 0.1 mm at the most. It is thus impossible to form a wide and long, i.e., wide area, magnetic sheet for display having a uniform thickness in a thickness range of 0.1 to 0.2 mm without possibility of breakage and hole formation, and as noted above the obtainable sheet size is up to A4 to A3 sizes at the most.

### SUMMARY OF THE INVENTION

The invention has an object of providing a magnet sheet for display, which, although wider and longer than A3 to A4 sizes, has a uniform desired thickness free from breakage or hole formation, is capable of being readily printed using a plotter, a copier or like printing machine, is excellent in the magnetizing property and enables production of a magnetically attachable large advertisement poster, which could have not heretofore existed. To attain this object, a epoch-making method is contrived, in which a paste sheet composed of magnetic particles and synthetic resin material and having a predetermined desired width and a thickness close to a desired thickness, is formed quickly and readily without having resort to a rolling system having multiple roller stages but by using an extrusion molding machine, and in the next step its thickness is adjusted to the desired thickness with adjusting rollers. Thus, it is possible to quickly and readily obtain a large size and thin magnetic sheet for display, which can be readily printed using a copier, a printer or like printing machine and is excellent in the magnetic attachment property.

### BRIEF DESCRIPTION OF THE DRAWINGS

FIG. 1 is a sectional view showing a magnet sheet for display according to the invention;

FIG. 2 is a schematic view for describing a method of manufacturing magnetic sheets for display according to the invention;

FIG. 3 is a view showing an extrusion molding machine used in the method of manufacturing magnet sheets for display according to the invention;

FIG. 4 is a view for describing adjustment rollers used in the method of manufacturing magnetic sheets for display according to the invention; and

FIG. 5 is a view for describing a prior art method of manufacture based on calendar rollers.

### DETAILED DESCRIPTION OF THE PREFERRED EMBODIMENTS

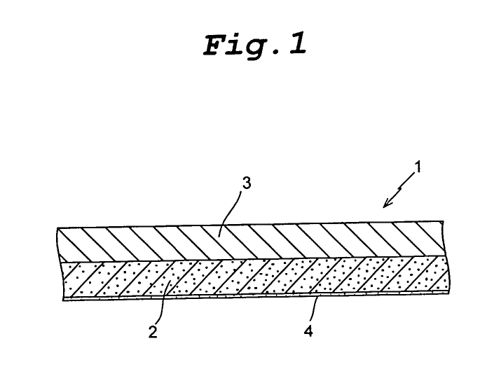

FIG. 1 shows a first embodiment of the magnet sheet for display according to the invention. In the Figure, reference numeral 1 designates a magnet sheet for display having a width of 600 mm or more and a length which can be set as desired. Reference numeral 2 designates a magnet sheet, which is formed by forming a sheet-like mixture of a synthetic resin material and magnetic particles to a thickness of 0.1 to 0.2 mm and multiple-pole magnetizing at least one surface to alternate N and S poles. Reference numeral 3 is a print sheet constituted by paper, such as high grade paper, coated paper, etc., synthetic paper or synthetic resin film having a thickness of 0.1 to 0.2 mm and laminated on one surface of the magnetic sheet 2. Reference numeral 4 designates an anti-shift material coated on the magnetized surface of the magnet sheet 2. In a method of use of the magnet sheet 1 for display, a desired display such as a painting, letters, drawings, photographs, etc. is printed on the surface of the print sheet 3 using a plotter, a copier, a printer or like printing machine, and the printed magnet sheet is magnetically attached to a display member having a magnetic body, thus obtaining a large size display body such as an advertisement poster.

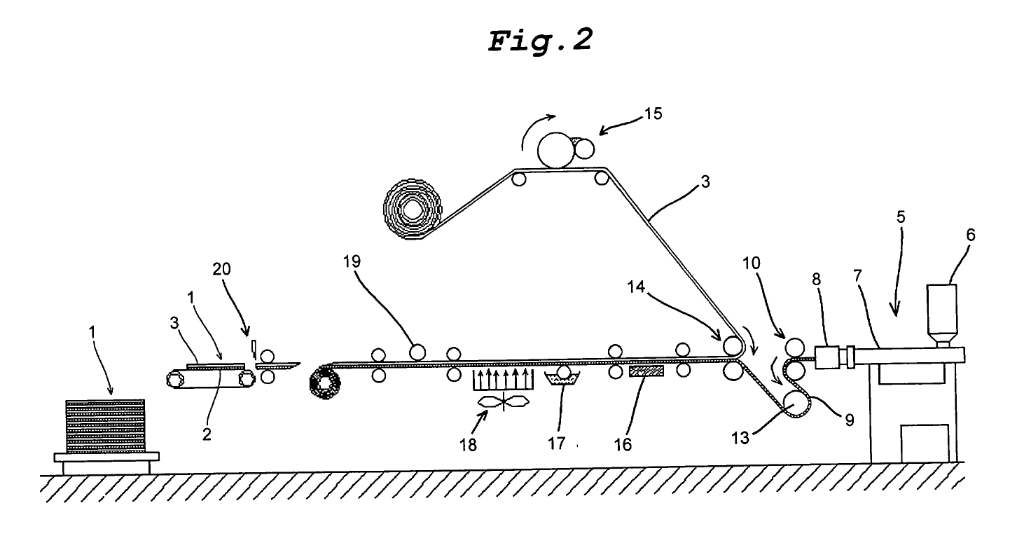

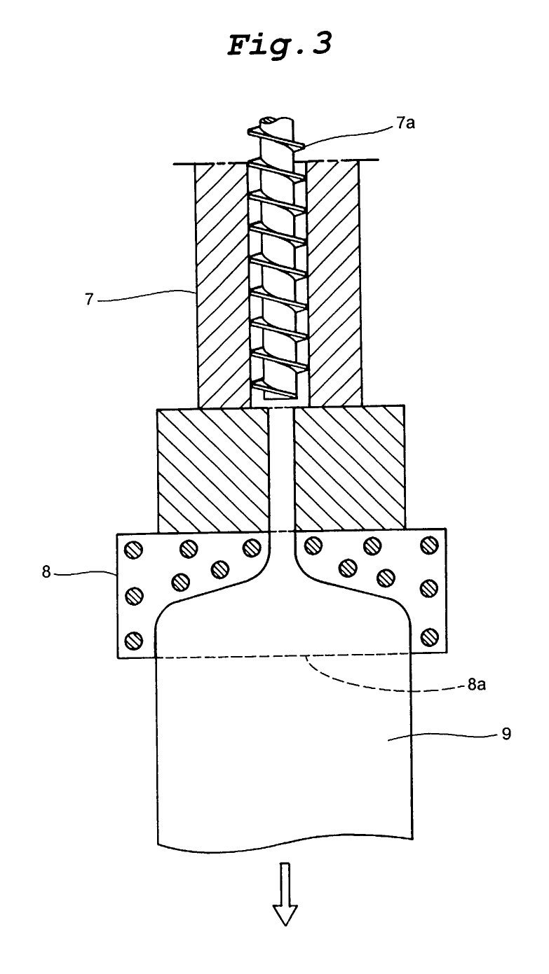

A method of manufacturing the magnet sheet for display will now be described. As shown in FIG. 2, a synthetic resin material and magnetic particles are charged into a hopper 6 of an extrusion molding machine 5. As for the mixing ratio between the synthetic resin material and the magnetic particles, when the magnetic particles are insufficient, the magnetic attaching force becomes insufficient. When the magnetic articles are excessive, on the other hand, the synthetic resin material serving as binder becomes insufficient for the formation of the paste sheet. In this embodiment, the proportion of the magnetic particles in the paste is set to 85 to 95% by weight. The synthetic resin material and magnetic particles in the hopper 6 are fed into an extruder 7 having an internal screw 7a to be thermally fused, kneaded and pressed and then fed into a die 8 having a wide opening nozzle 8a (having a width of about 600 to 1,000 mm) for extrusion molding. The nozzle 8a specifically has a width corresponding to the desired width of the magnet sheet for display and a thickness dimension set to be close to the desired thickness of the magnetic sheet for display. As shown in FIG. 3, the die 8 has a cavity of substantially hanger-like shape with the width thereof sharply or quickly increased as one goes from its inlet provided adjacent to the extruder 7 in the paste feed-out direction toward the nozzle. Thus, heavy and highly viscous paste composed of the fused synthetic resin material and magnetic particles can be smoothly guided toward the wide opening nozzle 8a. It is thus possible to extrusion mold a paste sheet 9 having a desired width and a uniform thickness (for instance 0.2 to 0. 5 mm) without irregularities and close to a desired thickness.

The die shape as noted above has an effect of maintaining the mechanical strength of the die 8 in addition to the effect of smoothly guiding the paste up to the nozzle. The paste composed of the fused synthetic resin material and magnetic particles has high proportion of magnetic particles, and its specific gravity is very high compared to the case of the sole synthetic resin material. Therefore, the die 8 is liable to be broken (or opened in the case of an abutment die) by great force exerted by the pressed paste. To cope with this, it is required to secure together the upper and lower die halves with powerful bolt-nuts in as broad area as possible and make the area of the cavity not permitting the use of any bolt-nut to be as small as possible. By forming the die to have a substantially hanger-like shape as described above, the length of the die can be reduced, and it is thus possible to provide a die which can suitably withstand high pressure.

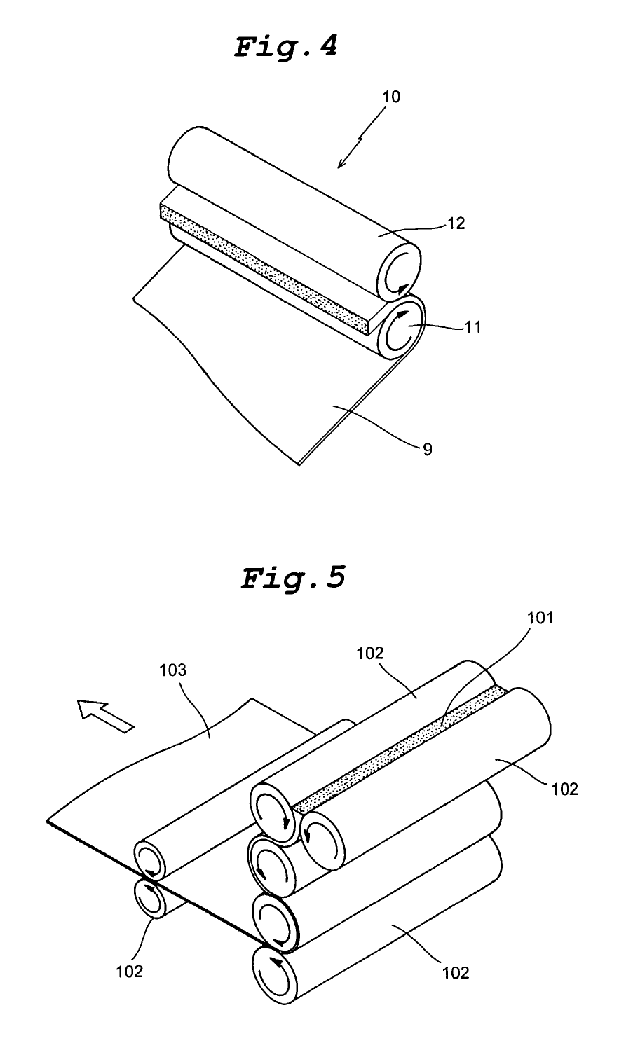

As shown in FIG. 4, the paste sheet 9 extrusion formed to have a desired width and a uniform thickness close to a desired thickness, is passed between two rollers disposed as adjustment rollers 10 in the proximity of the die nozzle, and is rolled as it is pulled out. As a result, a thin sheet having a desired thickness having a desired thickness of 0.1 to 0.2 mm is formed. It is a feature of the embodiment that, while in the prior art calendar roller case the two opposed rollers with the sheet passed there between are both driven for rotation, as the adjustment rollers 10 in this embodiment are such that only the lower roller as shown in FIGS. 1 and 4 is a driven roller 11 which is driven for rotation for transporting the paste sheet 9 and that the upper roller opposing the driven roller 11 is a free roller 12 which is not self-driven for rotation but is rotated by a driven force transferred from the progressively transferred paste sheet 9.

In the case of driving both the opposed rollers for rotation, the following problems are posed. A first problem is that the rolled sheet is subject to strain generation and deforming as it sticks not only to the lower roller but also to the upper roller. Another problem is that when the sheet inserted between the two rollers has slight thickness irregularities, it is fed in and out from the two rollers with thicker parts of the sheet in an irrationally compressed state. Therefore, after the sheet has been fed out, its thicker portions which have been compressed more than the other portions restore the initial state. Consequently, the thickness irregularities are not removed. In contrast, with the adjustment rollers 10 in this embodiment, the free roller 12 is not self-driven. Thus, the fed-in sheet does not possibly stick but is always guided downward along the driven roller 11, thus maintaining stable quality. The free roller 12 does not irrationally compress the irregular thickness sheet. Instead, the free roller 12 has an action of braking the sheet, thus providing for collection of thicker sheet portions in front of the roller portions about to be brought into forced contact. In this way, the thickness irregularities of the sheet are removed, and the thickness of the paste sheet 9 is uniformly adjusted to a desired thickness of 0.1 to 0.2 mm corresponding to the clearance between the driven and free rollers 11 and 12 set as the adjustment rollers 10.

The paste sheet 9 fed out from the adjustment rollers 10 is still hot and readily deformable. Accordingly, a cooling roller 13 for cooling the paste sheet 9 is disposed right underneath the adjustment rollers 10 to cool the paste sheet 9 down to a temperature near normal temperature by suitable means such as air cooling or water cooling. The cooled-down paste sheet 9 is laminated on and bonded to a synthetic resin print sheet 3 with adhesive coated thereon by laminating rollers 14. Reference numeral 15 designates a roll coater for uniformly coating the adhesive on one surface of the print sheet 3.

For the print sheet 3, sheet-like paper of cellulose fibers, art paper or coated paper produced by subjecting the sheet-like paper to surface treatment, synthetic paper constituted by a synthetic resin thin film obtained by adding white earth to synthetic resin material or making the material to be porous, synthetic resin film, etc. are appropriately selected by taking printing means used, purpose of use, cost, etc. into considerations. Suitably, synthetic resin film is used for advertisement poster, high grade paper for use in printing with a copier, and coated paper and art paper for use in printing with an ink jet printer or the like.

The paste sheet 9 with the print sheet 3 laminated thereon is fed to a step of multiple-pole magnetizing one surface (or both surfaces) of the magnetic sheet 2 to alternate N and S poles. The magnetic sheet 2 is magnetized with a magnetizing force, which is ten times or more of the weight of the magnet sheet 1 for display. Thus, the magnetic sheet 1 for display can be reliably held magnetically attached to even a vertical magnetic surface without possibility of its falling.

In a subsequent step, an anti-shift material 4 for preventing the magnet sheet 2 from becoming bonded to the magnetically attached surface, is coated to a thickness of about several μm on the magnetic attachment surface of the magnet sheet by a coating machine 17 and dried by a drier 18. Thus, a large size magnet sheet 1 for display, which has a thickness of about 0.2 mm, a width of 600 to 1,000 mm and a length capable of being set as desired, is completed. This magnet sheet 1 is provided to the market as a sheet roll having an adequate length or after cutting it to adequate sizes by using a splitter 19 and/or a cutter 20. The product thus provided is used by printing a desired display, such as a painting, letters, drawings and photographs, on the surface of the print sheet 3 with a plotter, a copier, a printer or like printing machine.

As a different example of the above adjustment rollers 10, the lower roller is a main driven roller, and the upper roller is a subordinate driven roller which is driven at a lower rotational speed than the rotational speed of the main driven roller. Again in this case, the subordinate driven roller has substantially the same function and effects as the non-driven free roller 12 in the above embodiment. Specifically, it is not possible that the fed-out paste sheet sticks to the subordinate driven roller, and irregular thickness parts of the paste sheet are braked. Thus it is possible to form an uniform paste sheet without thickness irregularities.

In the above embodiment, the print sheet 3 is laminated on one surface of the magnetic sheet 2. However, although not shown, it is also possible to laminate print sheets on both surfaces of the magnet sheet.

As has been described in the foregoing, the magnet sheet for display according to the invention is obtained by laminating a print sheet of paper or synthetic resin film having a width of 600 mm or more, a length capable of being set as desired and a thickness of 0.1 to 0.2 mm to either one or each surface of a magnetic sheet having a thickness of 0.1 to 0.2 mm and capable of being magnetically attached to a magnetic surface, and permits a large size display article such as a wide and long advertisement poster, which can be readily printed and has excellent magnetic attachment performance, to be obtained by printing a display, such as a painting, letters, drawings and photographs, on the print sheet surface of the magnetic sheet using a plotter, a copier, a printer or like printing machine.

As for the method of manufacturing the magnet sheet for display according to the invention, it is contrived an art of charging a synthetic resin material and magnetic particles into an extruding machine of an extrusion molding machine for kneading together therein, feeding out the paste thus formed into a die, which is disposed adjacent to the extrusion molding machine and has a wide opening nozzle, so as to extrude a thin film-like paste sheet of the synthetic resin material and magnetic particles having a desired width and a thickness close to a desired thickness from the die, passing this paste sheet between two adjustment rollers disposed as the next stage, thus forming a thin film-like sheet having a desired thickness, laminating, in the next stage, a print sheet of paper or synthetic resin film, on which a painting, letters, drawings, photographs, etc. can be printed with a plotter, a copier, a printer or like printing machine, on the paste sheet and magnetizing the paste sheet in the next stage. Thus, it is made possible to overcome all the drawbacks inherent in the prior art calendar machine, which is liable to produce breakage or hole formation of a wide and long sheet so that it is inevitable to limit the product sheet size to A4 to A3 sizes, thus enabling the production of a thin, wide and long magnetic particle/synthetic resin blend sheet having a uniform thickness. A heretofore unseen large size magnet sheet for display, which permits ready printing and is excellent in the magnetic attachment performance, is thus obtainable.

It is to be emphasized that the epoch-making contrived art of quickly and readily forming a paste sheet, which has a preset desired width and a thickness close to a desired thickness, not in a multiple roller stage rolling system but by using an extrusion molding machine and, in the next stage, forming a paste sheet having the desired thickness by using adjustment rollers, permits quickly and readily obtaining a thin and large size magnet sheet for display, which can be readily printed using a copier, a printer or like printing machine and is also excellent in the magnetic attachment property. It is thus made possible to efficiently produce large size display posters for advertisement having excellent advertisement function.

The adjustment rollers for forming the paste sheet to the desired thickness are constituted by a driven roller driven for self-rotation to transport the paste sheet of the synthetic resin material and magnetic particles and a free roller opposing the driven roller and not driven for self-rotation but rotatable only by drive force transferred from the paste sheet being transported. It is thus not possible that the paste sheet to stick to and be guided by the driven roller is strained and deformed due to sticking to the free roller. Also, the paste sheet is not irrationally fed out by the thickness control rollers but can always be stably controlled to a high accuracy thickness by an action of braking it.

The adjustment rollers for forming the paste sheet to the desired thickness may also be constituted by a main driven roller driven for self-rotation to transport the paste sheet of synthetic resin material and magnetic particles and a subordinate driven roller opposing the main driven roller and driven for self-rotation at a rotational speed lower than the rotational speed of the main driven roller. It is thus not possible that the past sheet to stick to and be guided by the main driven roller is strained and deformed due to sticking to the subordinate driven roller. Also, the paste sheet is not irrationally fed out by the subordinate driven roller but can always be stably controlled to a high accuracy thickness by an action of braking it.

Furthermore, the die of the extrusion molding machine has a substantially hanger-like shape with the width thereof sharply increasing from the inlet in the paste feed-out direction. It is thus possible to smoothly guide the paste up to the wide opening nozzle and also reduce the cavity length to maintain the mechanical strength of the die.

What is claimed is:

1. A magnet sheet for display comprising a magnet sheet having a width of 600 mm or more, a length capable of being set as desired and a thickness of 0.1 to 0.2 mm and magnetically attachable to a magnetic surface and a print sheet of paper or a synthetic resin film having a thickness of 0.1 to 0.2 mm and laminated on either one or each surface of the magnet sheet, a desired display such as a painting, letters, drawings and photographs being printed on the surface of the print sheet by using a plotter, a copier, a printer or like printing machine.

2. A method of manufacturing a magnet sheet for display comprising the steps of charging a synthetic resin material and magnetic particles into an extruding machine of an extrusion molding machine for kneading together therein, feeding out the paste thus formed into a die disposed adjacent to the extruding machine and having a wide opening nozzle so as to feed out a thin film-like paste sheet of the synthetic resin material and magnetic particles having a desired width and a thickness close to a desired thickness from the die, passing, in the next stage, the paste sheet between two rollers provided as adjustment rollers to form a thin film-like sheet having a desired thickness, laminating, in the next stage, a print sheet of paper or synthetic resin film, which is capable of printing a painting, letters, drawings, photographs, etc. by a printing machine, a plotter and a copier, on the paste sheet, and magnetizing the paste sheet in the next stage.

3. The method of manufacturing a magnet sheet for display according to claim 2, wherein the adjustment rollers for forming the paste sheet to the desired thickness are constituted by a driven roller which is driven for self-rotation to transport the paste sheet of the synthetic resin material and magnetic particles, and a free roller opposing the driven roller and not self-rotatable but rotatable only by a drive force transferred from the paste sheet being transported.

4. The method of manufacturing a magnet sheet for display according to claim 2, wherein the adjustment rollers for forming the paste sheet are constituted by a main driven roller driven for self-rotation to transport the paste sheet of the synthetic resin material and magnetic particles and a subordinate driven roller opposing the main driven roller and self-rotated at a rotational speed lower than the rotation speed of the main driven roller.

5. The method of manufacturing a magnet sheet for display according to claim 2, wherein the die of the extrusion molding machine has a substantially hanger-like shape with the width thereof increasing sharply from an inlet in the paste feed direction.
